(19) United States
(12) Patent Application Publication
(10) Pub. No.: US 2026/0089486 A1
(43) Pub. Date: Mar. 26, 2026

(54) SUPPORTING UE MAXIMUM OUTPUT POWER DECLARATION AND CAPABILITY REPORTING

(71) Applicant: APPLE INC., Cupertino, CA (US)

(72) Inventors: Yuexia Song, Beijing (CN); Dawei Zhang, Saratoga, CA (US); Yang Tang, San Jose, CA (US); Jie Cui, San Jose, CA (US); Rolando E Bettancourt Ortega, Munich (DE); Qiming Li, Beijing (CN); Fangli Xu, Beijing (CN); Xiang Chen, Campbell, CA (US); Manasa Raghavan, Sunnyvale, CA (US)

(21) Appl. No.: 19/107,683

(22) PCT Filed: Sep. 23, 2022
(86) PCT No.: PCT/CN2022/120847

§ 371 Date: Feb. 28, 2025

(51) Int. Cl. H04W 8/18; H04W 52/28

(52) U.S. Cl. CPC H04W 8/18; H04W 52/28

(57) ABSTRACT

The disclosure relates to supporting UE maximum output power declaration and capability reporting. In some embodiments, there is provided a user equipment (UE), comprising at least one antenna, at least one radio coupled to the at least one antenna and a processor coupled to the at least one radio. The processor is configured to: configure a UE power capability indicator, the UE power capability indicator being associated with a UE maximum output power level of a plurality of UE maximum output power levels within a preconfigured power level range with a predefined granularity; and transmit, to a network, the UE power capability indicator.

### TECHNICAL FIELD

This application relates generally to wireless communication systems, including user equipments (UEs), base stations (BSs), methods, apparatus, and medium for supporting UE maximum output power declaration and capability reporting.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mm Wave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to user equipments (UEs), base stations, methods, apparatus, and medium for supporting UE maximum output power declaration and capability reporting.

In one aspect, there is provided a user equipment (UE), comprising at least one antenna, at least one radio coupled to the at least one antenna and a processor coupled to the at least one radio. The processor is configured to: configure a UE power capability indicator, the UE power capability indicator being associated with a UE maximum output power level of a plurality of UE maximum output power levels within a preconfigured power level range with a predefined granularity; and transmit, to a network, the UE power capability indicator.

In another aspect, there is provided a method, comprising: by a user equipment (UE), configuring a UE power capability indicator, the UE power capability indicator being associated with a UE maximum output power level of a plurality of UE maximum output power levels within a preconfigured power level range with a predefined granularity; and transmitting, to a network, the UE power capability indicator.

In another aspect, there is provided an apparatus for operating a user equipment (UE), comprising: a processor configured to cause the UE to perform a method as recited above.

In another aspect, there is provided a non-transitory computer-readable memory medium storing program instructions which, when executed at a user equipment (UE), cause the UE to perform a method as recited above.

In another aspect, there is provided a base station (BS), comprising at least one antenna, at least one radio coupled to the at least one antenna, and a processor coupled to the at least one radio. The processor is configured to: receive, from a UE, a UE power capability indicator, the UE power capability indicator being associated with a UE maximum output power level of a plurality of maximum output power levels within a preconfigured power level range with a predefined granularity; and determine the UE maximum output power level at least based on the UE power capability indicator.

In another aspect, there is provided a method, comprising: by a base station (BS) receiving from a UE a UE power capability indicator, the UE power capability indicator being associated with a UE maximum output power level of a plurality of maximum output power levels within a preconfigured power level range with a predefined granularity; and determining the UE maximum output power level at least based on the UE power capability indicator.

In another aspect, there is provided an apparatus for operating a base station (BS), comprising a processor configured to cause the BS to perform a method as recited above.

In another aspect, there is provided a non-transitory computer-readable memory medium storing program instructions which, when executed at a base station (BS), cause the BS to perform a method as recited above.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3A illustrates an example flowchart of a method performed by a UE, according to embodiments disclosed herein.

FIG. 3B illustrates an example flowchart of a method performed by a base station, according to embodiments disclosed herein.

FIG. 4 shows an example design for reporting a power class, according to embodiments disclosed herein.

FIG. 5A illustrates an example flowchart of a method performed by a UE, according to embodiments disclosed herein.

FIG. 5B illustrates an example flowchart of a method performed by a base station, according to embodiments disclosed herein.

FIG. 6 shows an example design for reporting a power class, according to embodiments disclosed herein.

FIG. 7A illustrates an example flowchart of a method performed by a UE, according to embodiments disclosed herein.

FIG. 7B illustrates an example flowchart of a method performed by a base station, according to embodiments disclosed herein.

FIG. 8 shows an example design for reporting a power class, according to embodiments disclosed herein.

FIG. 9A illustrates an example flowchart of a method performed by a UE, according to embodiments disclosed herein.

FIG. 9B illustrates an example flowchart of a method performed by a base station, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

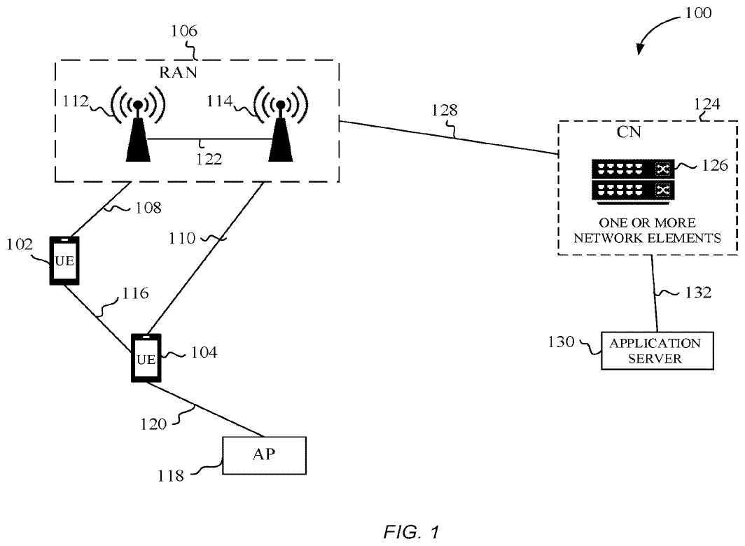

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR. In a case that the RAN 106 is an NTN-based NG-RAN architecture, the connection 108 and connection 110 are NR Uu interfaces.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

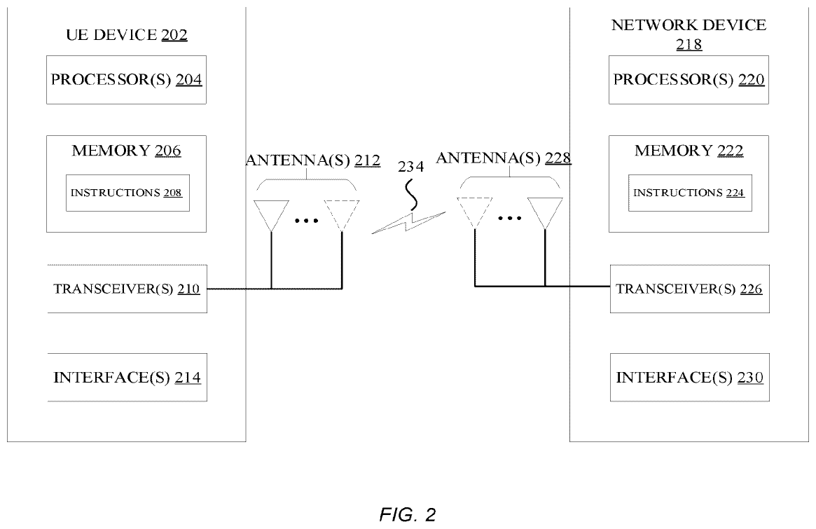

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Air-to-ground (ATG) network refers to in-flight connectivity technique, using ground-based cell towers that send signals up to an aircraft's antenna(s) of onboard ATG terminal. As a plane travels into different sections of airspace, the onboard ATG terminal automatically connects to the cell with strongest received signal power, just as a mobile phone does on the ground. In this network, a direct radio link will be established between BS on the ground and Customer Premise Equipment (CPE) type of UE mounted in the aircraft.

For ATG network deployment scenarios, on-board ATG terminal can be much powerful than normal terrestrial UE, e.g., with higher Equivalent Isotropically Radiated Power (EIRP) via much larger transmission power and/or much larger on-board antenna gain.

Current UE maximum output power capability is defined as the UE power classes. There are only a few of UE power classes defined in the first NR version for the handheld UE, and some new UE power classes are introduced case by case, e.g., for the high-power UE (HPUE) and the low-power UE (LPUE), in following releases.

The power classes defined in R15 only include pc1/pc2/pc3/pc4 and each is reported by specific signaling with “enumerated” data type. When a new power class is identified, an additional signaling needs to be introduced in a different release.

The following shows example signalings as defined in the prior art.
ue-PowerClass ENUMERATED {pc1, pc2, pc3, pc4} OPTIONAL
ue-PowerClass-v1610 ENUMERATED {pc1dot5} OPTIONAL
ue-PowerClass-v1700 ENUMERATED {pc5, pc6} OPTIONAL

As can be seen, when new power classes such as pc1.5, pc5, pc6 are identified, new siganlings such as ue-PowerClass-v1610 and ue-PowerClass-v1700 are introduced.

In the prior art, each power class corresponds to a predefined power level, e.g., 26 dBm or 23 dBm.

The drawback of the existing capability design is that the capability does not have good forward scalability/expansibility. It only supports a power class with a fixed power level. Introduction of new power levels results in new power classes and new signaling.

Regarding ATG UE output power capability, different from a handheld UE, the ATG UE output power may be determined based on custom demand according to the intended type of aircraft to be equipped with and the link budget for a specific scenario. It is desired to provide more flexibility for ATG UE vendor in power design as well as enrich the deployment scenarios.

Regarding future communication systems e.g., 6G system, the UE output power may become more variety. It is desired to provide a design for UE output power reporting with signaling which will not be affected by the new UE power capability introduced in future.

### Overview

The disclosure introduces a new forward-compatible method for UE to report the UE maximum output power capability to the network, in which the signaling will not be impacted by the new UE power capability introduced in future.

A power level range is defined to address various applications including handheld UE, CPE, HPUE and LPUE and the like. The upper bound of the power level range may be up to e.g., 36 dBm. The lower bound of the power level range may be down to several dBm, e.g., 10dBm. New signaling is introduced to support reporting of the above power level range with a suitable granularity.

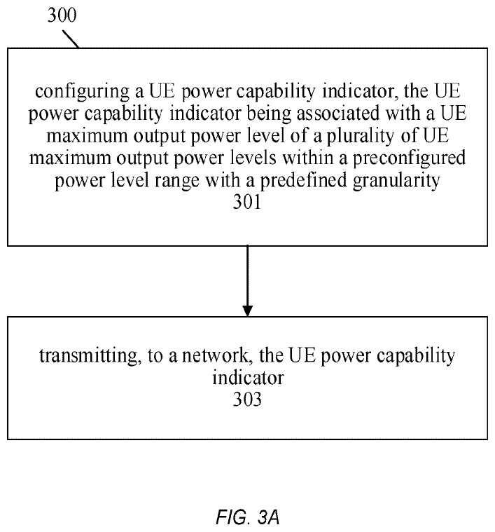

FIG. 3A illustrates an example flowchart of a method 300 performed by a UE, according to embodiments disclosed herein.

As shown in FIG. 3A, the method 300 may comprise an operation 301, at which the UE configures a UE power capability indicator. The UE power capability indicator may be associated with a UE maximum output power level of a plurality of UE maximum output power levels within a preconfigured power level range with a predefined granularity.

In some embodiments, the UE power capability indicator may include a UE power class of a plurality of UE power classes corresponding to the plurality of maximum output power levels within the preconfigured power level range with the predefined granularity.

The preconfigured power level range may comprise the plurality of maximum output power levels with the predefined granularity. The preconfigured power level range may be from X dBm to YdBm and the predefined granularity may be Z dBm. Those skilled in the art may set specific values of X, Y and Z according to design requirements.

For example, the preconfigured power level range may be from 10 dBm to 36 dBm, and the plurality of maximum output power levels may comprise 10 dBm, 11 dBm, 12 dBm . . . 35 dBm and 36 dBm with the predefined granularity of 1 dBm.

In some cases, the plurality of UE power classes may comprise 27 power classes with each power class being corresponding to a respective one of the plurality of maximum output power levels.

In some other cases, one UE power classes may be associated with two maximum output power levels with the same absolute offset value to a same default value. For example, there may be 14 power classes corresponding to the 27 maximum output power levels, in which 10 dbM and 36 dBm have the same absolute offset value 13 dBm to a default value of 23 dBm, and a power class may correspond to both dBm and 36 dBm.

Those skilled in the art can understand that the power level range and the granularity can be designed with different structures and values, without departing from the teaching of the disclosure.

As shown in FIG. 3A, the method 300 may further comprise an operation 303, at which the UE transmits, to a network, the UE power capability indicator.

In some embodiments, the UE transmits to the network the UE power capability indicator in UE capability Information Element (IE).

FIG. 3B illustrates an example flowchart of a method 3000 performed by a base station, according to embodiments disclosed herein.

As shown in FIG. 3B, the method 3000 may comprise an operation 3001, at which the base station receives, from a UE, a UE power capability indicator, the UE power capability indicator being associated with a UE maximum output power level of a plurality of maximum output power levels within a preconfigured power level range with a predefined granularity.

As shown in FIG. 3B, the method 3000 may further comprise an operation 3003, at which the base station determines the UE maximum output power level at least based on the UE power capability indicator.

In some embodiments, the UE power capability indicator may indicate the UE maximum output power level. In such a case, the base station may determine the UE maximum output power level based on the UE power capability indicator, e.g., by identifying the power class included in the UE power capability indicator.

In some embodiments, the UE power capability indicator may not indicate the UE maximum output power level itself, but it may indicate an offset to a predefined default value. In such a case, the base station may determine the maximum output power level based on the reported offset and the predefined default value.

In some other embodiments, the UE power capability indicator may not indicate the UE maximum output power level itself, but it may indicate an absolute offset to a predefined default value. In such a case, the base station may determine the maximum output power level based on the reported absolute offset, the predefined default value and other information reported from UE (e.g., the type of the UE).

First maximum output power reporting solution In some embodiments, the UE may declare the maximum output power in the range of e.g., 10˜36 dBm and reports it to the network. If not reported, it is 23 dBm power class by default. A new power class reporting may be designed with 5 bits overhead and 1 dB granularity.

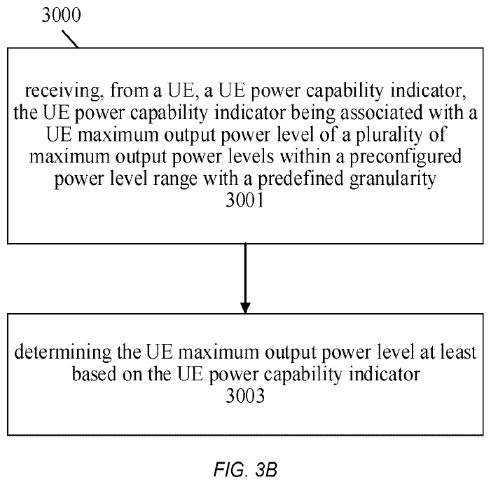

FIG. 4 shows an example design for reporting a power class, according to embodiments disclosed herein.

As shown in FIG. 4, the design defines a power range including 27 maximum output power levels, i.e., 10 dBm, 1 dBm . . . 36 dBm with the granularity of 1 dBm. The design uses corresponding 27 power classes, i.e., Powerclass_0 to Powerclass_26, for reporting. Each power class corresponds to a certain maximum output power level.

In FIG. 4, Powerclass_13 may not be reported. In some embodiments, if the UE does not report any power class, by default, the network deems the UE has the maximum output power level of 23 dBm.

In such a case, the network can determine the maximum output power level from the reported power class.

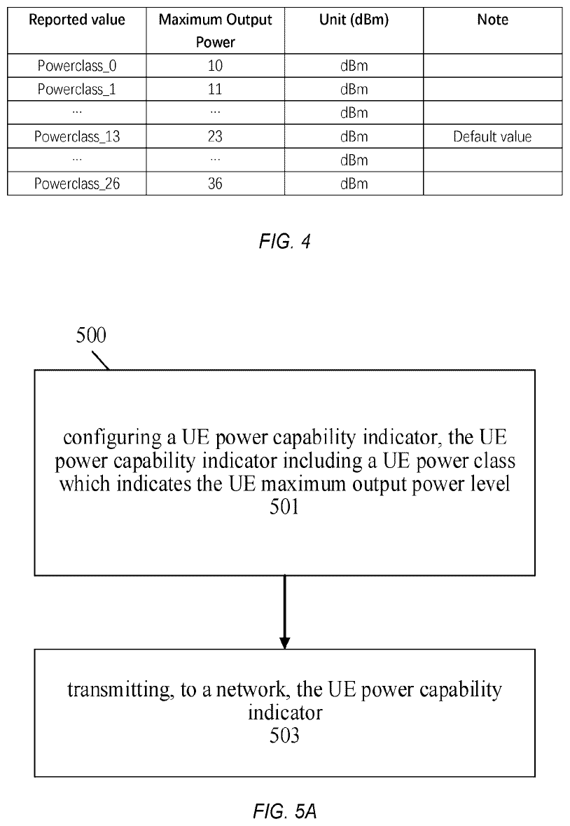

FIG. 5A illustrates an example flowchart of a method 500 performed by a UE, according to embodiments disclosed herein.

As shown in FIG. 5A, the method 500 may comprise an operation 501, at which the UE configures a UE power capability indicator, the UE power capability indicator including a UE power class which indicates the UE maximum output power level.

As shown in FIG. 5A, the method 500 may comprise an operation 503, at which the UE transmits, to a network, the UE power capability indicator.

FIG. 5B illustrates an example flowchart of a method 5000 performed by a base station, according to embodiments disclosed herein.

As shown in FIG. 5B, the method 5000 may comprise an operation 5001, at which the base station receives, from a UE, a UE power capability indicator, the UE power capability indicator including a UE power class which indicates the UE maximum output power level.

The method 5000 may comprise an operation 5003, at which the base station determines the UE maximum output power level from the UE power class.

Second maximum output power reporting solution

In some embodiments, the UE declares it's maximum output power offset value to 23 dBm, e.g., in the range of +/−13 dBm, and reports it to the network. If not reported it is 0dBm offset by default. A new power class reporting may be designed with 5 bits overhead and 1 dB granularity.

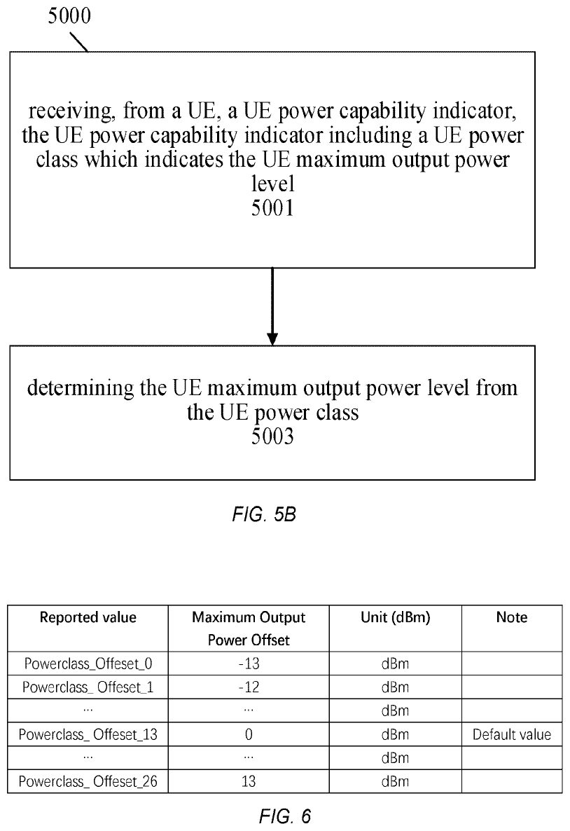

FIG. 6 shows an example design for reporting a power class, according to embodiments disclosed herein.

As shown in FIG. 6, the design defines a power range including 27 maximum output power levels, i.e., 10 dBm, 11 dBm . . . 36 dBm with the granularity of 1 dBm. The design uses corresponding 27 power classes, i.e., Powerclass_Offset_0 to Powerclass_Offset_26, for reporting. Each power class corresponds to a certain maximum output power offset (i.e., −13, −12 . . . 12, or 13) to the predefined default value, e.g., 23 dBm.

In FIG. 6, Powerclass_13 may not be reported. In some embodiments, if the UE does not report any power class, by default, the network deems the UE has the maximum output power offset of 0 dBm to the predefined default value of 23 dBm.

In such a case, for a reported power class, the network calculates the UE's maximum output power by adding 23 dBm and the offset value indicated by the power class.

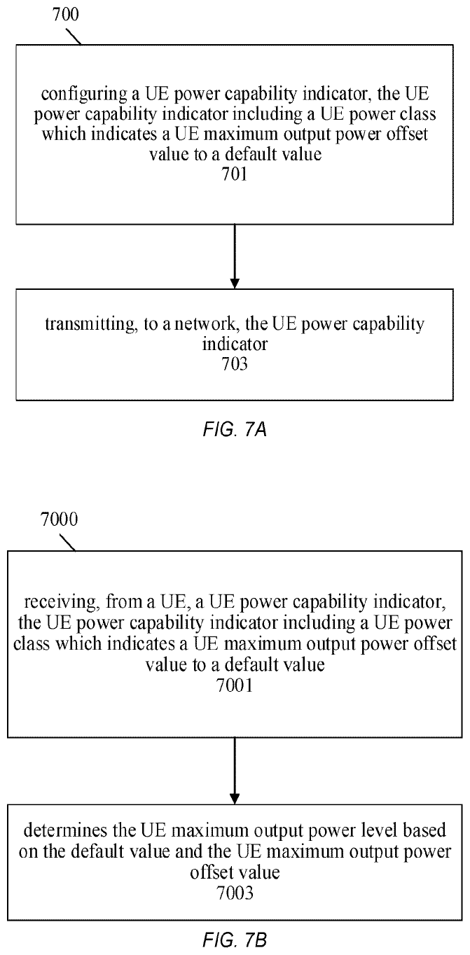

FIG. 7A illustrates an example flowchart of a method 700 performed by a UE, according to embodiments disclosed herein.

As shown in FIG. 7A, the method 700 may comprise an operation 701, at which the UE configures a UE power capability indicator, the UE power capability indicator including a UE power class which indicates a UE maximum output power offset value to a default value.

As shown in FIG. 7A, the method 700 may comprise an operation 703, at which the UE transmits, to a network, the UE power capability indicator.

FIG. 7B illustrates an example flowchart of a method 7000 performed by a base station, according to embodiments disclosed herein.

As shown in FIG. 7B, the method 7000 may comprise an operation 7001, at which the base station receives, from a UE, a UE power capability indicator, the UE power capability indicator including a UE power class which indicates a UE maximum output power offset value to a default value.

The method 7000 may comprise an operation 7003, at which the base station determines the UE maximum output power level based on the default value and the UE maximum output power offset value.

In some embodiments, the base station calculates the UE maximum output power level by adding the default value and the UE maximum output power offset value as indicated by the UE power class.

Third maximum output power reporting solution

The UE declares the absolute value of the maximum output power offset to 23 dBm, e.g., in the range of 0 . . . 13 dBm, and reports it to the network. If not reported it is 0 dBm offset by default. A new power class reporting may be designed with 4 bit overhead and 1 dB granularity.

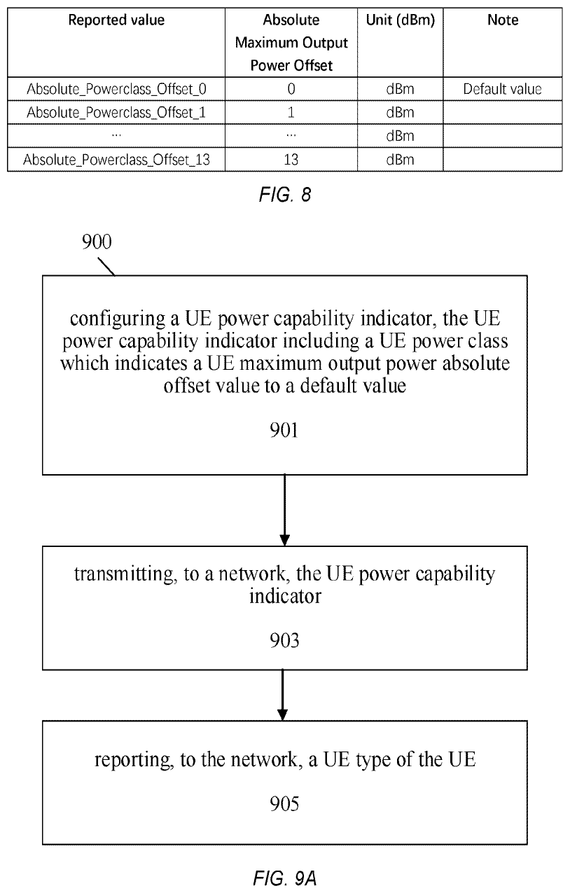

FIG. 8 shows an example design for reporting a power class, according to embodiments disclosed herein.

As shown in FIG. 8, the design defines a power range including 27 maximum output power levels, i.e., 10 dBm, 11 dBm . . . 36 dBm with the granularity of 1 dBm. The design uses 14 power classes, i.e., Absolute_Powerclass_Offset_0 to Absolute_Powerclass_Offset_13, for reporting. Each power class corresponds to a certain maximum output power absolute offset to the predefined default value, e.g., 23 dBm.

In FIG. 8, Absolute_Powerclass_Offset_0 may not be reported. In some embodiments, if the UE does not report any power class, by default, the network deems the UE has the maximum output power offset of 0 dBm to the predefined default value of 23 dBm.

In such a case, the network may decide the offset direction (“+” or “−”) by conjunction with other capability reporting and calculates the UE's maximum output power by 23 dBm +/− the offset value indicated by the reported power class. For example, if the UE indicates it is some “LPUE” type, then the offset direction will be “−”. If it is an ATG UE, the offset direction will be “+”.

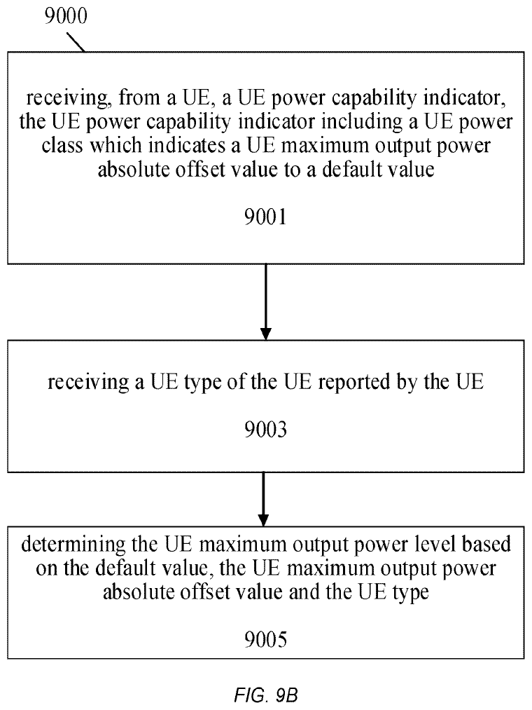

FIG. 9A illustrates an example flowchart of a method 900 performed by a UE, according to embodiments disclosed herein.

As shown in FIG. 9A, the method 900 may comprise an operation 901, at which the UE configures a UE power capability indicator, the UE power capability indicator including a UE power class which indicates a UE maximum output power offset value to a default value.

As shown in FIG. 9A, the method 900 may comprise an operation 903, at which the UE transmits, to a network, the UE power capability indicator.

As shown in FIG. 9A, the method 900 may comprise an operation 903, at which the UE reports, to a network, a UE type of the UE.

FIG. 9B illustrates an example flowchart of a method 9000 performed by a base station, according to embodiments disclosed herein.

As shown in FIG. 9B, the method 9000 may comprise an operation 9001, at which the base station receives, from a UE, a UE power capability indicator, the UE power capability indicator including a UE power class which indicates a UE maximum output power absolute offset value to a default value.

As shown in FIG. 9B, the method 9000 may comprise an operation 9003, at which the base station receives a UE type of the UE reported by the UE.

The UE type may comprise but not be limited to HPUE, LPUE, ATG UE or conventional handheld UE.

As shown in FIG. 9B, the method 9000 may comprise an operation 9005, at which the base station determines the UE maximum output power level based on the default value, the UE maximum output power absolute offset value and the UE type.

Those skilled can understand that the example designs described with reference to FIGS. 4, 6 and 8 are presented to help understand the spirit of the disclosure. Those skilled in the art can make various deformations according to the teaching of the disclosure. The example methods and systems are described with reference to NR, but can also be applied to next generation, e.g., 6G.

Embodiments contemplated herein include an apparatus comprising means to perform one or more elements of the method 300, 500, 700, and 900. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 300, 500, 700, and 900. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 300, 500, 700, and 900. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 300, 500, 700, and 900. This apparatus may be, for example, an apparatus of a UE (such as a wireless device 202 that is a UE, as described herein).

Embodiments contemplated herein include a signal as described in or related to one or more elements of the method 300, 500, 700, and 900.

Embodiments contemplated herein include a computer program or computer program product comprising instructions, wherein execution of the program by a processor is to cause the processor to carry out one or more elements of the method 300, 500, 700, and 900. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method 3000, 5000, 7000, and 9000. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 3000, 5000, 7000, and 9000. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 3000, 5000, 7000, and 9000. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 3000, 5000, 7000, and 9000. This apparatus may be, for example, an apparatus of a base station (such as a network device 218 that is a base station, as described herein).

Embodiments contemplated herein include a signal as described in or related to one or more elements of the method 3000, 5000, 7000, and 9000.

Embodiments contemplated herein include a computer program or computer program product comprising instructions, wherein execution of the program by a processing element is to cause the processing element to carry out one or more elements of the method 3000, 5000, 7000, and 9000. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the processor is configured to:
configure a UE power capability indicator, the UE power capability indicator being associated with a UE maximum output power level of a plurality of UE maximum output power levels within a preconfigured power level range with a predefined granularity; and
transmit, to a network, the UE power capability indicator.

2. The UE of claim 1, wherein the UE power capability indicator includes a UE power class of a plurality of UE power classes corresponding to the plurality of maximum output power levels within the preconfigured power level range with the predefined granularity.

3. The UE of claim 2, wherein the UE power class indicates the UE maximum output power level, wherein the network determines the UE maximum output power level from the UE power class.

4. The UE of claim 2, wherein the UE power class indicates a UE maximum output power offset value to a first default value, wherein the network determines the UE maximum output power level based on the first default value and the UE maximum output power offset value.

5. The UE of claim 2, wherein the UE power class indicates a UE maximum output power absolute offset value to a second default value, the processor is further configured to report a UE type of the UE to the network,
wherein the network determines the UE maximum output power level based on the second default value, the UE maximum output power absolute offset value and the UE type.

6. The UE of claim 5, wherein the UE type includes one of the following:
High Power UE (HPUE);
Low Power UE (LPUE);
Air to Ground (ATG) UE;
conventional handheld UE.

7. The UE of claim 1, wherein the preconfigured power level range is from 10 dBm to 36 dBm.

8. The UE of claim 1, wherein the predefined granularity is 1 dBm.

9. The UE of claim 1, wherein the UE power capability indicator is included in UE capability Information Element (IE).

10. A method, comprising:
by a user equipment (UE),
configuring a UE power capability indicator, the UE power capability indicator being associated with a UE maximum output power level of a plurality of UE maximum output power levels within a preconfigured power level range with a predefined granularity; and
transmitting, to a network, the UE power capability indicator.

11-12. (canceled)

13. A base station (BS), comprising:
at least one antenna;
at least one radio coupled to the at least one antenna; and
a processor coupled to the at least one radio;
wherein the processor is configured to:
receive, from a UE, a UE power capability indicator, the UE power capability indicator being associated with a UE maximum output power level of a plurality of maximum output power levels within a preconfigured power level range with a predefined granularity; and
determine the UE maximum output power level at least based on the UE power capability indicator.

14. The BS of claim 13, wherein the UE power capability indicator includes a UE power class of a plurality of UE power classes corresponding to the plurality of maximum output power levels within the preconfigured power level range with the predefined granularity.

15. The BS of claim 14, wherein the UE power class indicates the UE maximum output power level, the processor is further configured to determine the UE maximum output power level from the UE power class.

16. The BS of claim 14, wherein the UE power class indicates a UE maximum output power offset value to a first default value, the processor is further configured to determine the UE maximum output power level based on the first default value and the UE maximum output power offset value.

17. The BS of claim 14, wherein the UE power class indicates a UE maximum output power absolute offset value to a second default value, the processor is further configured to:
receive a UE type of the UE reported by the UE, and
determine the UE maximum output power level based on the second default value, the UE maximum output power absolute offset value and the UE type.

18-20. (canceled)
